(19) United States
(12) Patent Application Publication
(10) Pub. No.: US 2022/0107187 A1
(43) Pub. Date: Apr. 7, 2022

(54) ROUTE RETRIEVAL DEVICE AND COMPUTER PROGRAM

(71) Applicant: TOYOTA JIDOSHA KABUSHIKI KAISHA, Toyota-shi (JP)

(72) Inventors: Hidefumi OKABE, Kariya-shi (JP); Koichi IWATSUKI, Kariya-shi (JP); Motohiro NAKAMURA, Okazaki-shi (JP)

(73) Assignee: TOYOTA JIDOSHA KABUSHIKI KAISHA, Toyota-shi (JP)

(21) Appl. No.: 17/493,148

(22) Filed: Oct. 4, 2021

(30) Foreign Application Priority Data
Oct. 6, 2020 (JP) 2020-168900

(51) Int. Cl. G01C 21/34; G01C 21/36

(52) U.S. Cl. CPC G01C 21/3423; G01C 21/3679; G01C 21/3626

(57) ABSTRACT

A route retrieval device retrieves a route to a destination, guides a user with route information for identifying the retrieved route, selects one section included in the retrieved route as a change target section based on a user's later operation, select a new transportation means for movement in the change target section, and re-retrieves a route to the destination based on the premise that the user moves in the change target section using the selected new transportation means.

### CROSS-REFERENCE TO RELATED APPLICATION

This application claims priority to Japanese Patent Application No. 2020-168900 filed on Oct. 6, 2020, incorporated herein by reference in its entirety.

### BACKGROUND

### 1. Technical Field

The present disclosure relates to a route retrieval device and a computer program that retrieve a route to a destination.

### 2. Description of Related Art

Various devices having a route retrieval function of retrieving a recommended movement route to a designated destination using map information or the like by allowing a user to designate the destination are known. Examples of such a device include a navigation device which is an onboard device, a mobile phone, a smartphone, a tablet type terminal, and a personal computer. In such retrieval of a movement route, optimal transportation means are appropriately selected out of a plurality of transportation means (for example, walking, a private vehicle, a bus, and a train) and the movement route to a destination is retrieved by combining the selected transportation means.

For example, Japanese Unexamined Patent Application Publication No. 2002-296071 (JP 2002-296071 A) discloses a technique of retrieving a movement route to a destination by combining a plurality of transportation means such as walking, a taxi, and a train and guiding a user with the movement route when the user inputs retrieval conditions such as a departure time and an arrival time along with the destination using a mobile phone.

### SUMMARY

In the route retrieval technique using a plurality of transportation means which is described in JP 2002-296071 A, what transportation means is used in what section is basically determined by a device side that performs retrieval. A user side can set retrieval conditions such as a departure time and an arrival time, but there is a problem in that a movement route retrieved based on the retrieval conditions may not necessarily be a movement route desired by a user. Retrieving a plurality of candidates for a movement route to a destination and presenting the plurality of retrieved candidates to a user is performed, but even when a plurality of candidates is retrieved, a movement route desired by a user cannot be said to necessarily be included among the plurality of candidates.

The present disclosure provides a route retrieval device and a computer program that can enable easy retrieval of a route desired by a user when a transportation means which is used for movement is selected out of a plurality of types of transportation means and route retrieval is performed.

According to an aspect of the present disclosure, there is provided a route retrieval device including: a route retrieving unit configured to retrieve a route to a destination which is divided into one or more sections and in which a transportation means recommended for movement in a section is designated out of a plurality of types of transportation means for each section; a route guidance unit configured to guide a user with route information for identifying a retrieved route which is a route retrieved by the route retrieving unit; a section selecting unit configured to select one section included in the retrieved route as a change target section based on a user's operation; a transportation means selecting unit configured to select a new transportation means for movement in the change target section based on the user's operation; and a route re-retrieving unit configured to re-retrieve a route to the destination based on the premise that the user moves in the change target section using the new transportation means selected by the transportation means selecting unit.

The “premise that the user moves in the change target section using the new transportation means selected by the transportation means selecting unit” may include a condition that the user moves in the whole change target section using the new transportation means or may include a condition that the user moves in at least a part of the change target section using the new transportation means.

According to another aspect of the present disclosure, there is provided a computer program for retrieving a route to a destination. Specifically, the computer program causes a computer to serve as: a route retrieving unit configured to retrieve a route to a destination which is divided into one or more sections and in which a transportation means recommended for movement in a section is designated out of a plurality of types of transportation means for each section; a route guidance unit configured to guide a user with route information for identifying a retrieved route which is a route retrieved by the route retrieving unit; a section selecting unit configured to select one section included in the retrieved route as a change target section based on a user's operation; a transportation means selecting unit configured to select a new transportation means for movement in the change target section based on the user's operation; and a route re-retrieving unit configured to re-retrieve a route to the destination based on the premise that the user moves in the change target section using the new transportation means selected by the transportation means selecting unit.

With the route retrieval device and the computer program having the aforementioned configurations according to the present disclosure, when a transportation means used for movement is selected out of a plurality of types of transportation means and a route is retrieved, the user can edit a temporarily retrieved route to a route in which the user moves in an arbitrary section designated by the user using a transportation means designated by the user and thus it is possible to easily retrieve a route desired by the user.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is diagram schematically illustrating a configuration of a route retrieval system according to an embodiment;

FIG. 2 is a block diagram illustrating the configuration of the route retrieval system according to the embodiment;

FIG. 3 is a block diagram illustrating a configuration of an information terminal according to the embodiment;

FIG. 4 is a flowchart illustrating a route retrieval processing program according to the embodiment;

FIG. 5 is a diagram illustrating an example in which route information is displayed;

FIG. 6 is a diagram illustrating an example in which a route editing screen is displayed;

FIG. 7 is a diagram illustrating an example in which a route editing screen is displayed;

FIG. 8 is a diagram illustrating an example in which new edited route information is displayed;

FIG. 9 is a flowchart illustrating a sub processing program of the route retrieval processing program;

FIG. 10 is a diagram illustrating a method of retrieving a route to a destination when a user moves using a station type transportation means;

FIG. 11 is a diagram illustrating a method of retrieving a route to a destination when a user moves by transferring between a plurality of station type transportation means;

FIG. 12 is a flowchart illustrating a sub processing program of a route re-retrieval processing program;

FIG. 13 is a diagram illustrating an example in which a route is edited when a transportation means for movement in a change target section is changed to a transportation means other than a station type transportation means;

FIG. 14 is a diagram illustrating an example in which a route is edited when a transportation means for movement in a change target section is changed to a transportation means other than a station type transportation means;

FIG. 15 is a diagram illustrating an example in which a route is edited when a transportation means for movement in a change target section is changed to a station type transportation means; and

FIG. 16 is a diagram illustrating an example in which a route is edited when a transportation means for movement in a change target section is changed to a station type transportation means.

### DETAILED DESCRIPTION OF EMBODIMENTS

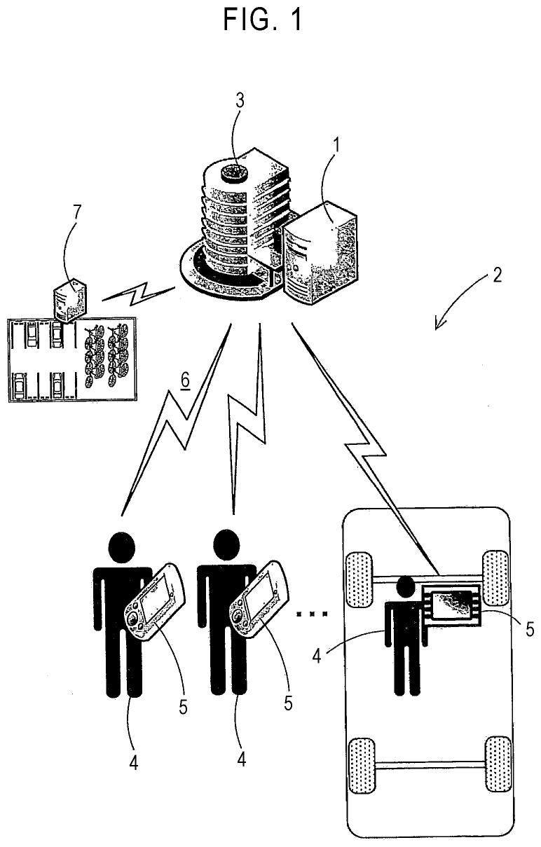

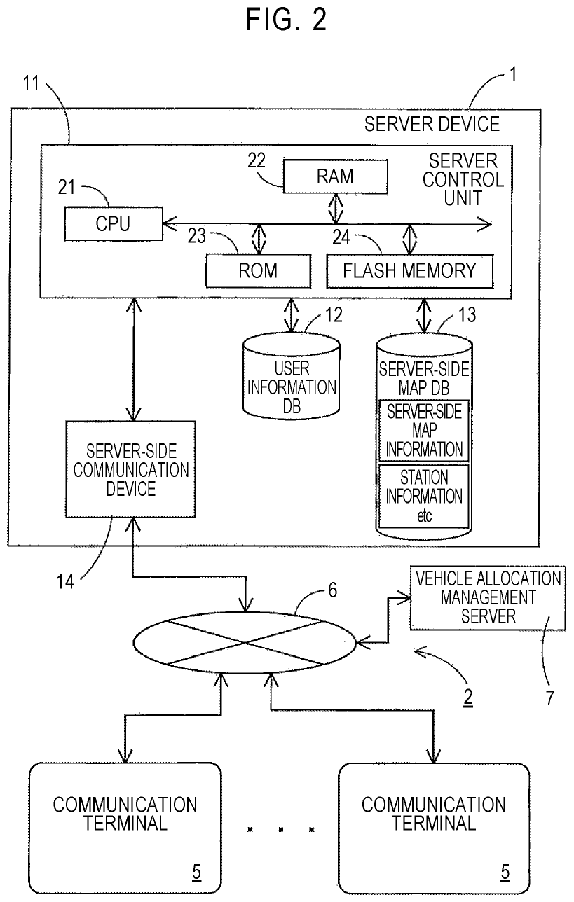

Hereinafter, an embodiment in which a route retrieval device according to the present disclosure is embodied as a server device 1 will be described in detail with reference to the accompanying drawings. An outline configuration of a route retrieval system 2 including the server device 1 according to an embodiment will be described first with reference to FIGS. 1 and 2. FIG. 1 is diagram schematically illustrating a configuration of the route retrieval system 2 according to an embodiment. FIG. 2 is a block diagram illustrating the configuration of the route retrieval system 2 according to the embodiment.

As illustrated in FIG. 1, the route retrieval system 2 according to this embodiment basically includes a server device 1 that is provided in an information delivery center 3 and an information terminal 5 that is carried by a user 4. The server device 1 and the information terminal 5 are configured to transmit and receive electronic data to and from each other via a communication network 6. Examples of the information terminal 5 include a mobile phone, a smartphone, a tablet type terminal, a personal computer, and a navigation device which is an onboard device. The user 4 may be in a vehicle or may not be in a vehicle.

The server device 1 performs retrieval of a route in response to a request from the information terminal 5. Specifically, when a destination is set in the information terminal 5 or when a route re-retrieving process (rerouting) is performed, information required for route retrieval such as a departure place or a destination is transmitted from the information terminal 5 to the server device 1 along with a route retrieval request (here, information on a destination is not necessarily transmitted in the case of re-retrieval). The server device 1 having received the route retrieval request performs route retrieval using map information stored in the server device 1 and identifies a recommended route from a departure place to a destination. Thereafter, the server device 1 transmits the identified recommended route to the information terminal 5 which is a request source. Then, the information terminal 5 provides information on the received recommended route to a user or sets the recommended route as a guidance route and performs movement guidance along the guidance route. Accordingly, even when map information stored in the information terminal 5 at the time of route retrieval is map information of an old version or map information is not stored in the information terminal 5, it is possible to provide an appropriate recommended route to a destination based on map information of a newest version stored in the server device 1. Particularly, in this embodiment, when a route from a departure place to a destination is retrieved, retrieval of a recommended route is performed in consideration of movement while switching between a plurality of transportation means such as walking, a private vehicle, a rented vehicle, a shared vehicle, a shared bicycle, a railway, a bus, a ferry, and an aircraft.

The server device 1 is communicatively connected to a vehicle allocation management server 7 that manages taxis, rented vehicles, shared vehicles, shared bicycles, and the like in every region of the country. The vehicle allocation management server 7 may include a server that manages taxis, a server that manages rented vehicles, a server that manages shared vehicles, and a server that manages shared bicycles as different servers.

The vehicle allocation management server 7 monitors changes in availability of taxis, rented vehicles, shared vehicles, and shared bicycles which are managed. The vehicle allocation management server 7 also performs management of reservation for taxis, rented vehicles, shared vehicles, and shared bicycles. When the server device 1 performs route retrieval, the vehicle allocation management server 7 provides information on availability of a taxi, a rented vehicle, a shared vehicle, or a shared bicycle to the server device 1. The vehicle allocation management server 7 also performs reservation for allocation of taxis and reservation for use of rented vehicles, shared vehicles, and shared bicycles in response to a request from the server device 1.

The route retrieving process is not necessarily performed by the server device 1 and may be performed by an information terminal 5 when the information terminal 5 includes map information. The information terminal 5 may directly perform acquisition of availability of taxis, rented vehicles, shared vehicles, and shared bicycles and reservation for use thereof via the vehicle allocation management server 7 without using the server device 1.

On the other hand, as the information terminal 5, an information terminal which is carried by a user 4 and includes a navigation function is used, and examples thereof include a mobile phone, a smartphone, a tablet type terminal, a personal computer, and a navigation device which is an onboard device.

The navigation function corresponds to functions of displaying route information for identifying a route retrieved by the server device 1, displaying a map image near a current position of the user 4 based on map data acquired from a server or stored in a memory, displaying the current position of the user 4 on a displayed map image, and performing movement guidance along a set guidance route. Not all the functions of the navigation function need to be provided in the information terminal 5, and the present disclosure can be embodied as long as the navigation function includes at least a function of displaying route information.

The communication network 6 includes a plurality of base stations disposed in every region of the country and communication companies that manage and control the base stations, and is configured by connecting the base stations and the communication companies in a wired manner (such as optical fiber or ISDN) or in a wireless manner. Each base station includes a transceiver (transmitter and receiver) and an antenna for communication with the information terminal 5. Each base station wirelessly communicates with the communication companies and serves as a terminal of the communication network 6 to relay communication of the information terminal 5 with the server device 1 in a range (a cell) which is reached by radio waves of the base station.

The configuration of the server device 1 in the route retrieval system 2 will be described below in more detail with reference to FIG. 2. As illustrated in FIG. 2, the server device 1 includes a server control unit 11, a user information DB 12 that is an information storage unit connected to the server control unit 11, a server-side map DB 13, and a server-side communication device 14.

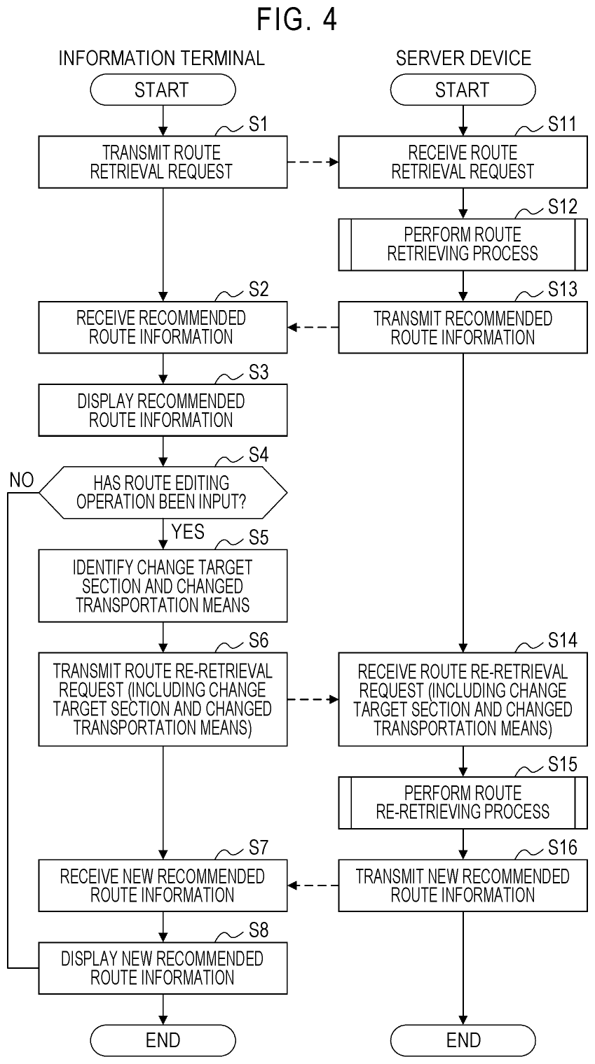

The server control unit 11 is a control unit (such as an MCU or an MPU) that comprehensively controls the server device 1 and includes a CPU 21 that serves as a calculator and a controller and an internal storage device such as a RAM 22 used as a work memory for the CPU 21 to perform various calculations, a ROM 23 having a route retrieval processing program (FIG. 4) which will be described later in addition to a control program stored, and a flash memory 24 storing a program read from the ROM 23. The server control unit 11 includes various means serving as processing algorithms along with a control unit of the information terminal 5 which will be described later. For example, a route retrieving unit retrieves a route to a destination which is divided into one or more sections and in which a transportation means recommended for movement in a section is designated out of a plurality of types of transportation means for each section. A route guidance unit guides a user with route information for identifying a retrieved route which is a route retrieved by the route retrieving unit. A section selecting unit selects one section included in the retrieved route as a change target section based on a user's operation. A transportation means selecting unit selects a new transportation means for movement in the change target section based on the user's operation. A route re-retrieving unit re-retrieves a route to the destination based on the premise that the user moves in the change target section using the new transportation means selected by the transportation means selecting unit.

The user information DB 12 is a storage unit that stores registration information of a user who has registered for use. Examples of the registration information stored in the user information DB 12 include an ID, an address, a name, a phone number, and an e-mail address of a user and credit card information which is used for charge settlement of a rented vehicle or a shared vehicle. It is preferable that an ID (for example, OpenID (registered trademark)) which is shared by the vehicle allocation management server 7 be used as the ID for identifying a user. By using an ID shared by the vehicle allocation management server 7, the server device 1 can perform reservation for allocation of a taxi, reservation for use of a rented vehicle, a shared vehicle, or a shared bicycle, and the like via the vehicle allocation management server 7.

On the other hand, the server-side map DB 13 is a storage unit in which server-side map information which is map information of a newest version registered based on input data or an input operation from the outside is stored. The server-side map information includes various types of information required for route retrieval, route guidance, and map display such as road networks. For example, the server-side map information includes network data including nodes and links representing the road networks, link data on roads (links), node data on nodes, crossing data on crossings, spot data on spots such as facilities, map display data for displaying a map, retrieval data for retrieving a route, and search data for searching for spots.

The server-side map DB 13 also stores various types of information for retrieving a route using transportation means (hereinafter referred to as station type transportation means) of which start and end of movement is possible at specific points (hereinafter referred to as stations) such as a rented vehicle, a shared vehicle, a shared bicycle, a train, a bus, a ferry, and an aircraft. Specifically, the server-side map DB 13 stores information of positions of stations of the station type transportation means (a station, a ferry port, an airport, a car rental shop, and a place for rental and return of a shared vehicle or a shared bicycle) and information of routes of the station type transportation means (train routes, bus routes, or routes of aircraft or ferries). The server-side map DB 13 also stores information of a timetable for each station for a transportation means with a timetable. The information on the station type transportation means may not be stored in the server-side map DB 13 but may be acquired from an external server.

On the other hand, the server-side communication device 14 is a communication device that communicates with the information terminal 5 or the vehicle allocation management server 7 via the communication network 6. The server-side communication device 14 can also receive traffic information including various types of information such as congestion information, regulation information, and traffic accident information which are transmitted from the Internet or a traffic information center such as a vehicle information and communication system (VICS (registered trademark)) instead of the information terminal 5 or the vehicle allocation management server 7.

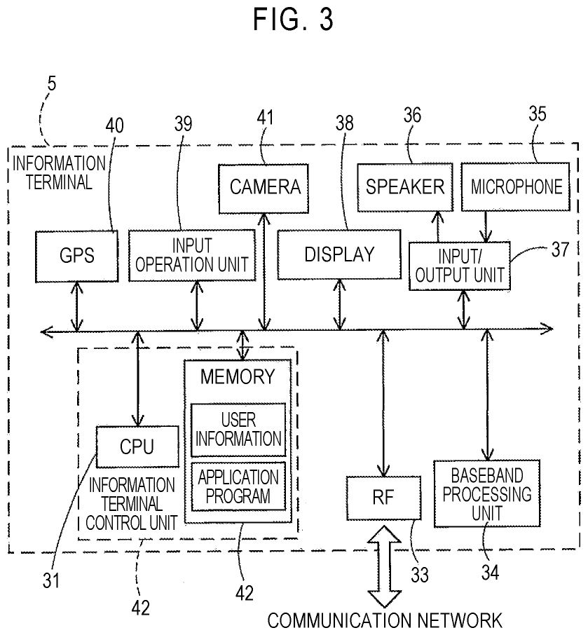

An outline configuration of the information terminal 5 will be described below with reference to FIG. 3. FIG. 3 is a block diagram schematically illustrating a control system of the information terminal 5 according to this embodiment. In the following description, it is assumed that the information terminal 5 is a smartphone.

As illustrated in FIG. 3, the information terminal 5 has a configuration in which a CPU 31, a memory 32 in which user information (such as a user ID and a name) of a user 4 who carries the information terminal 5 is stored, a transceiver circuit unit (RF) 33 that transmits and receives a signal to and from a base station of the communication network 6, a baseband processing unit 34 that converts a radio frequency (RF) signal received by the transceiver circuit unit 33 to a baseband signal and converts a baseband signal to an RE signal, an input/output unit 37 that is an interface with a microphone 35 and a speaker 36, a display 38 that is configured by a liquid crystal display panel or the like, an input operation unit 39 that is configured by a touch panel, hard buttons, and the like, a GPS 40, and a camera 41 are connected to a data bus BUS.

Here, the CPU 31 incorporated in the information terminal 5 is a control means for the information terminal 5 that performs various operations in accordance with an operation program stored in the memory 32 and constitutes an information terminal control unit 42 along with the memory 32. Various process details of the information terminal control unit 42 are displayed on the display 38 according to necessity.

The memory 32 is a storage medium in which user information (such as a user ID and a name) of the user 4 who carries the information terminal 5 is stored. The memory 32 also stores various application programs including a route retrieval processing program which will be described later (FIG. 4). The memory 32 may store map information. When map information is stored in the memory 32, processes associated with route retrieval can also be performed by the information terminal 5 instead of the server device 1. The memory 32 may be configured by a hard disk, a memory card, or the like.

As the display 38 disposed on one surface of a housing, a liquid crystal display or an organic EL display is used. The display 38 displays a top screen for executing various applications installed in the information terminal 5, a screen associated with an executed application (such as an Internet screen or an e-mail screen), or various types of information such as an image or a moving image. When route retrieval is performed, the display 38 also displays route information for identifying a retrieved route.

The input operation unit 39 includes a touch panel disposed on the front surface of the display 38 and hard buttons disposed in the housing. The information terminal control unit 42 performs control such that various corresponding operations are performed based on electrical signals which are output by pressing the touch panel or the hard buttons, or the like. Particularly, in this embodiment, the input operation unit 39 is operated by a user when the user wants to edit a route with respect to route information displayed on the display 38. The input operation unit 39 may include various keys such as number/text input keys, a cursor key for moving a cursor for selecting displayed details, and a decision key for settling selection.

The GPS 40 can detect a current location of the information terminal 5 (that is, the user 4) and a current date and time by receiving radio waves generated from artificial satellites. Another device (for example, a gyro sensor) for detecting a current location or a direction of the information terminal 5 may be provided in addition to the GPS 40.

The camera 41 is a small imaging device that includes a camera using a solid-state imaging device such as a CCD and is incorporated into a rear surface of the information terminal 5. In a state in which a dedicated application program has been started, the user can image surroundings by operating the input operation unit 39. A captured image captured by the camera 41 is stored in the memory 32.

A route retrieval processing program which is executed by the server device 1 and the information terminal 5 having the aforementioned configurations will be described below with reference to FIG. 4. FIG. 4 is a flowchart illustrating the route retrieval processing program according to this embodiment. Here, the route retrieval processing program is a program that is executed after a navigation application has been started in the information terminal 5, retrieves a route to a destination according to a user's operation, and provides route information for identifying a retrieved route. The programs illustrated as flowcharts in FIGS. 4, 9, and 12 are stored in the memory 32 of the information terminal 5 or the RAM 22 or the ROM 23 of the server device 1, and are executed by the CPU 31 or the CPU 21.

The route retrieval processing program which is executed by the information terminal 5 will be described below first. In Step (hereinafter simply abbreviated to S, which also applies to other steps) 1, the CPU 31 transmits a route retrieval request to the server device 1. The route retrieval request includes a terminal ID for identifying the information terminal 5 which is a transmission source of the route retrieval request, a user ID for identifying a user, information for identifying a departure place (for example, a current location of the user) and a destination, and retrieval conditions of a route which is set by the user in the information terminal 5 which is the transmission source. The “retrieval conditions of a route” include, for example, a desired departure time and a desired arrival time. The “departure place,” the “destination,” and the “retrieval conditions for a route” can be input by a user's operation on an input screen (not illustrated) for the retrieval conditions which is displayed on the information terminal 5.

Then, in S2, the CPU 31 receives information on a recommended route from the departure place to the destination (hereinafter referred to as a center route) which has been retrieved by the server device 1 in response to the route retrieval request. Here, the center route received in S2 is a recommended route from the departure place to the destination which has been retrieved using map information of a newest version in the server device 1 based on the route retrieval request transmitted from the information terminal 5. Details of retrieval of the center route in the server device 1 will be described later.

In this embodiment, when the center route is retrieved, a recommended route is retrieved in consideration of movement while switching between a plurality of transportation means such as walking, a private vehicle, a rented vehicle, a shared vehicle, a shared bicycle, a railway, a bus, a ferry, and an aircraft (multimodal). Accordingly, information on the center route transmitted from the server device 1 includes information for dividing the center route into one or more sections and designating a transportation means which is recommended for movement in a section for each section.

In S2, when a point at which the transportation means is switched (hereinafter referred to as a nodal point) is present in the center route, the CPU 31 receives information on the nodal point from the server device 1. Examples of the nodal point include a station, a bus stop, a parking lot, a car rental shop, a ferry port, and an airport and examples of information on the nodal point include a position of the nodal point, a name of the nodal point (a station name, a bus stop name, or a parking lot name), and a use charge or availability when the nodal point is a parking lot.

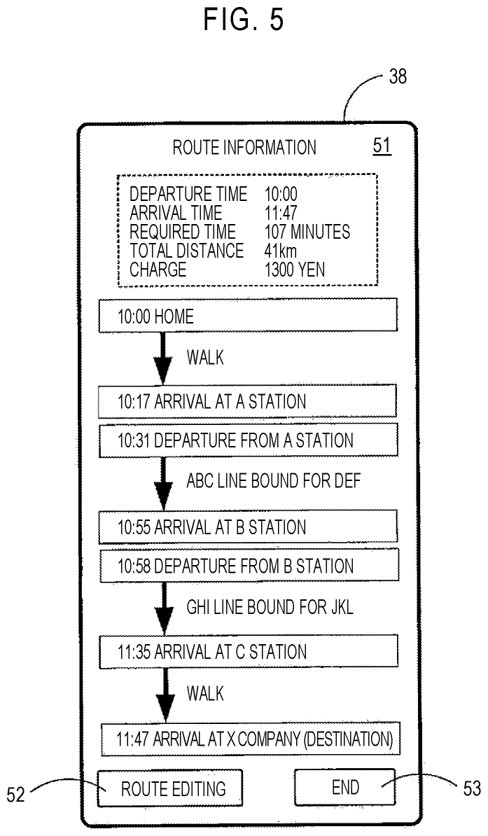

Thereafter, in S3, the CPU 31 displays the route information for identifying the center route which has been received in S2 on the display 38. FIG. 5 is a diagram illustrating an example of the route information which is displayed on the display 38 in S3.

As illustrated in FIG. 5, a route guidance screen 51 divides a route from a departure place to a destination into a plurality of sections as the route information for identifying the center route and displays information on nodal points serving as boundaries between the sections and information on a transportation means for each section in a time series. The route guidance screen 51 also displays information such as a scheduled departure time, a scheduled arrival time, a required time, a total length of the route, and a charge required for movement.

For example, FIG. 5 illustrates an example of route information which is displayed when route retrieval is performed in a state in which a departure place is a user's home, a destination is set to an X company, and 10:00 is set as a desired departure time. In the center route illustrated in FIG. 5, the nodal points are designated as three points of “A station,” “B station,” and “C station,” the transportation means from the departure place to “A station” is designated as walking, the transportation means from “A station” to “B station” is designated as a train of an ABC line bound for DEF, the transportation means from “B station” to “C station” is designated as a train of a GHI line bound for JKL, and the transportation means from “C station” to the destination is designated as walking.

A user can ascertain how to move to a destination using what transportation means is appropriate with reference to the route guidance screen 51. The center route may be displayed on an image displayed on a map. A route editing button 52 and an end button 53 are disposed below the route guidance screen 51, and the user sees the displayed route information of the center route and then operates the route editing button 52 when the user wants to edit the center route. As a result, it is possible to allow the user to designate and edit an arbitrary section as will be described later and to change a transportation means which is currently designated for the section to another transportation means. On the other hand, when the user wants to end guidance of the route information, the user operates the end button 53.

In S4, the CPU 31 determines whether the route editing button 52 has been operated, that is, whether the user wants to edit the center route for which guidance is performed. When the route editing button 52 has been operated, that is, when the user wants to edit the center route for which guidance is performed (S4: YES), the process flow proceeds to S5. On the other hand, when the route editing button 52 has not been operated, that is, when the user does not want to edit the center route for which guidance is performed (S4: NO), the route retrieval processing program ends.

In S5, the CPU 31 updates the route guidance screen 51 and displays a route editing screen 55. In the route editing screen 55, an operation of selecting one section included in the center route for which guidance is performed in S3 as a change target section and an operation of selecting a new transportation means which a user wants to use for movement in the change target section are received.

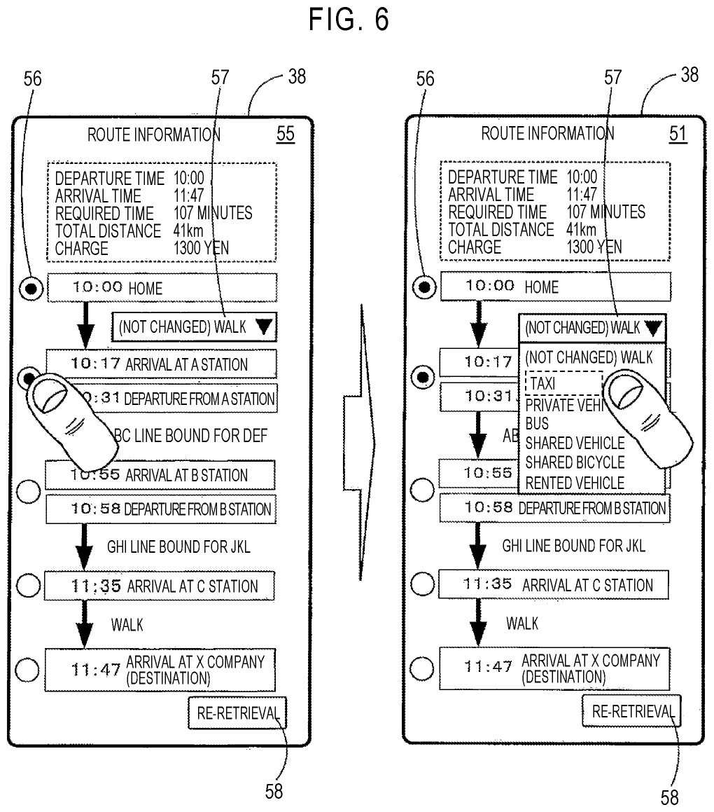

FIG. 6 is a diagram illustrating an example of the route editing screen 55 which is displayed on the display 38. As illustrated in FIG. 6, similarly to the route guidance screen 51, information on nodal points included in the center route and information on a transportation means for each section are displayed in a time series in the route editing screen 55. A selection icon 56 is displayed for each of a departure place, a destination, and the nodal points included in the center route. A user first selects the selection icon 56 corresponding to a departure place, a destination, or a nodal point corresponding to a start point of the change target section which the user wants to edit. Subsequently, the user selects the selection icon 56 corresponding to a departure place, a destination, or a nodal point corresponding to an end point of the change target section. Then, the CPU 31 identifies a section between two selection icons 56 which have been selected as the change target section. For example, in the example illustrated in FIG. 5, the selection icon 56 corresponding to a home which is a departure place and the selection icon 56 corresponding to an A station which is a nodal point are selected and a section “from the home to the A station” is identified as the change target section.

In the route editing screen 55, when two selection icons 56 are selected and the change target section is identified as illustrated in FIG. 6, an operation window 57 for selecting a new transportation means which the user wants to use for movement in the change target section is newly displayed. In the operation window 57, a list of all candidates for the transportation means which can move in the change target section is displayed such that a user can select a desired transportation means. Then, the CPU 31 identifies the transportation means selected in the operation window 57 as a new transportation means which the user wants to use for movement in the change target section. When there is a plurality of sections to be edited, the user repeatedly performs the operations of designating the change target section and selecting the transportation means. When the user pushes a re-retrieval button 58 disposed in the lower part of the route editing screen 55 after the user has completed the operations of designating the change target section and selecting the transportation means in the route editing screen 55, the CPU 31 ends receiving the operation of editing the center route and causes the process flow to proceed to S6.

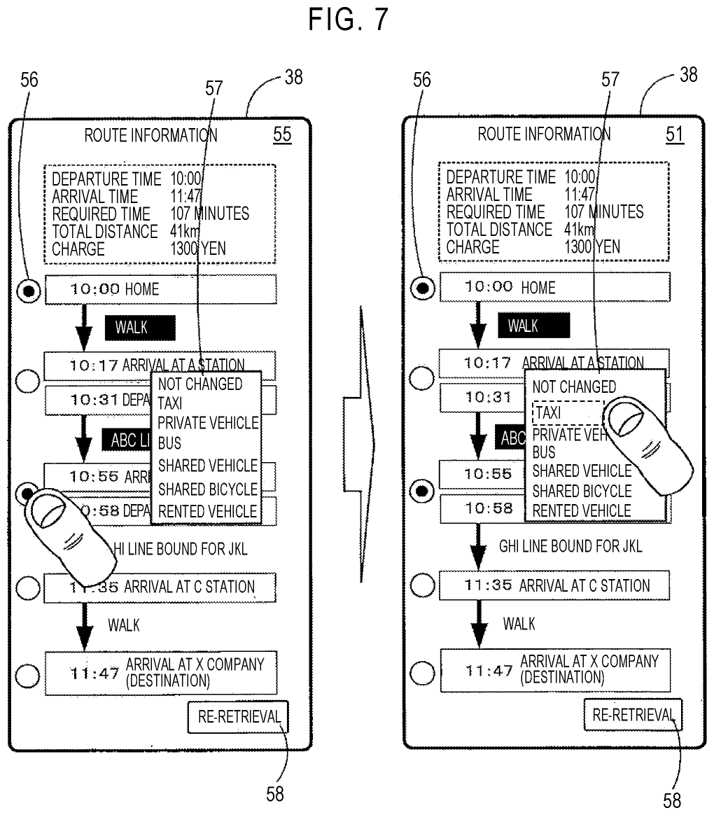

A plurality of neighboring sections as well as one section can also be collectively selected as the change target section. In this case, it is possible to move in the plurality of neighboring sections selected as the change target section using one transportation means, that is, to reduce the number of transfers of the transportation means. For example, in the example illustrated in FIG. 7, the selection icon 56 corresponding to the home which is a departure place and the selection icon 56 corresponding to the B station which is a nodal point are selected and a section “from the home to the B station” including two sections of the section “from the home to the A station” and the section “from the A station to the B station” is identified as the change target section. In this case, in the route editing screen 55, the operation window 57 for selecting a new transportation means which the user wants to use for movement in the change target section is newly displayed as illustrated in FIG. 7. In the operation window 57, a list of all candidates for the transportation means which can move in the change target section is displayed and the user can select a desired transportation means. Then, the CPU 31 identifies the transportation means selected in the operation window 57 as a new transportation means which the user wants to use for movement in the section “from the home to the B station.”

Subsequently, in S6, the CPU 31 transmits a route re-retrieval request to the server device 1. The route re-retrieval request includes the change target section identified in S5 and the new transportation means which the user wants to use for movement in the change target section.

Then, in S7, the CPU 31 receives information on a recommended route (hereinafter referred to as a new center route) from the departure place to the destination which is newly retrieved by the server device 1 in response to the route re-retrieval request. Here, the new center route received in S7 is a recommended route from the departure place to the destination which is retrieved using map information of the newest version in the server device 1 like the center route received in S2, but is retrieved based on the premise that the user moves in the change target section identified in S5 using the identified new transportation means. Details of retrieval of the new center route in the server device 1 will be described later.

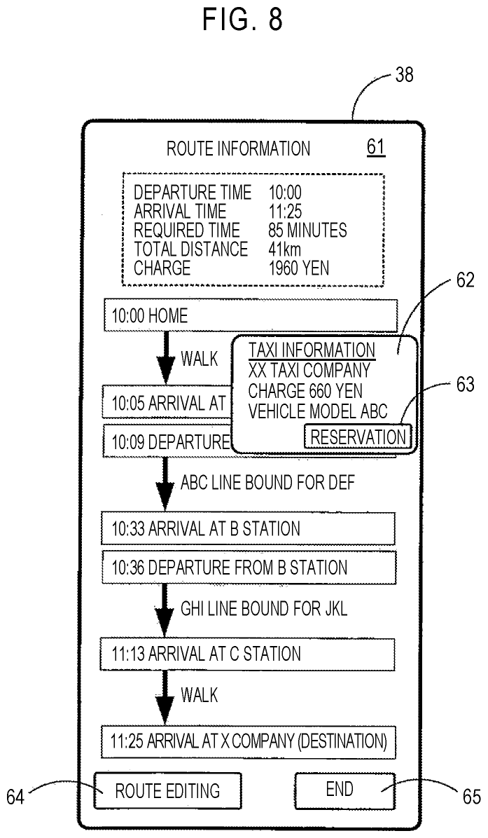

Thereafter, in S8, the CPU 31 displays route information for identifying the new center route received in S7 on the display 38. FIG. 8 illustrates an example of the route information which is displayed on the display 38 in S8.

As illustrated in FIG. 8, a route guidance screen 61 divides a route sequentially from a departure place to a destination into a plurality of sections as the route information for identifying the new center route and displays information on nodal points serving as boundaries between the sections and information on a transportation means for each section in a time series. The route guidance screen 61 also displays information such as a scheduled departure time, a scheduled arrival time, a required time, a total length of the route, and a charge required for movement.

FIG. 8 illustrates a new center route when the center route illustrated in FIG. 5 has been changed such that the user moves in the section “from the home to the A station” using a taxi. Accordingly, the new center route illustrated in FIG. 8 is different from the center route illustrated in FIG. 5, in that the transportation means from the departure place to the “A station” is replaced with a taxi and the nodal points subsequent to the A station and the arrival time at the destination are also changed. The required time and the charge required for movement are also changed.

When a transportation means for which reservation is required such as a taxi, a rented vehicle, a shared vehicle, or a shared bicycle is designated as the transportation means, a reservation window 62 is displayed. Details of the transportation means which can be reserved and a reservation button 63 are disposed in the reservation window 62. When reservation for the transportation means is wanted as displayed, the user operates the reservation button 63. When the reservation button 63 is operated, a reservation instruction is transmitted to the vehicle allocation management server 7 via the server device 1 and reservation for allocation of a taxi and reservation for use of a rented vehicle, a shared vehicle, or a shared bicycle are possible. When a transportation means for which reservation is required is designated in the route guidance screen 51 for the center route illustrated in FIG. 5, the reservation window 62 is displayed in the same way.

The user can understand how to move to a destination using what transportation means which is appropriate for the edited new center route with reference to the route guidance screen 61. The new center route may be displayed in an image displayed on a map. A route editing button 64 and an end button 65 are displayed in the lower part of the route guidance screen 61, and the user sees the displayed route information for the new center route and operates the route editing button 64 when the user wants to further edit the new center route. In this case, the process flow returns to S5 and the process of editing a route is performed again on the new center route. On the other hand, when the user wants to end guidance of route information, the user operates the end button 65.

A route retrieval processing program which is performed by the server device 1 will be described below. First, in S11, the CPU 21 receives a route retrieval request which is transmitted from an information terminal 5. The route retrieval request includes a terminal ID for identifying the information terminal 5 which is transmission source of the route retrieval request, information for identifying a departure place (for example, a current location of the user) and a destination, and route retrieval conditions.

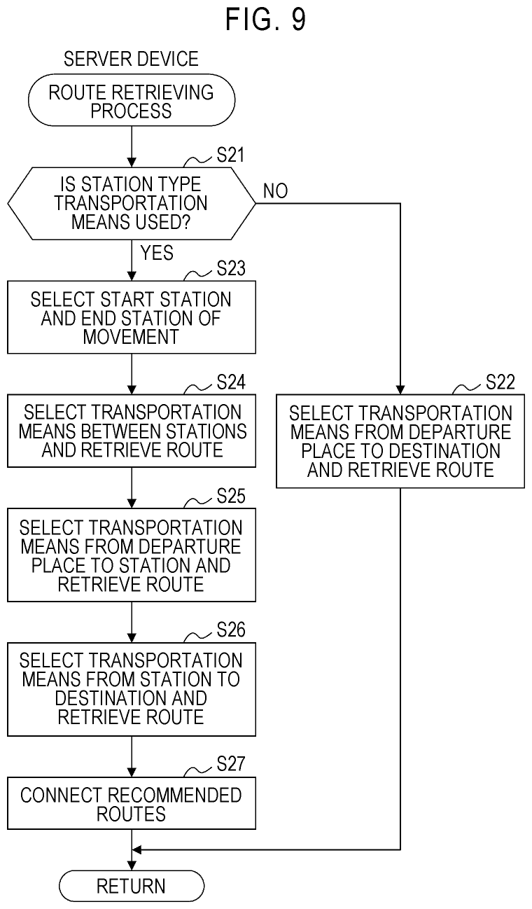

Thereafter, in S12, the CPU 21 performs a route retrieving process which will be described later (FIG. 9) based on the route retrieval request received in S11 and the map information stored in the server device 1. In the route retrieving process, a recommended route (a center route) from the departure place to the destination is retrieved using the map information of the newest version stored in the server device 1 based on the route retrieval request received from the information terminal 5. Particularly, when the center route is retrieved, retrieval of the recommended route is performed in consideration of movement while switching between a plurality of transportation means such as walking, a private vehicle, a rented vehicle, a shared vehicle, a shared bicycle, a train, a bus, a ferry, and an aircraft (multimodal).

Then, in S13, the CPU 21 transmits information on the center route retrieved in S12 to the information terminal 5 having transmitted the route retrieval request. The information on the center route includes information for dividing the center route into one or more sections and designating a recommended transportation means for movement in each section. When a nodal point at which the transportation means is switched is present in the center route, the information on the center route includes information on the nodal point.

The information terminal 5 to which the information on the center route has been transmitted guides a user on the information on the center route received as described above via the display 38 or the like (S3).

Thereafter, in S14, the CPU 21 receives a route re-retrieval request which is transmitted from the information terminal 5. The route re-retrieval request includes the change target section identified in S5 and a new transportation means which the user wants to use for movement in the change target section.

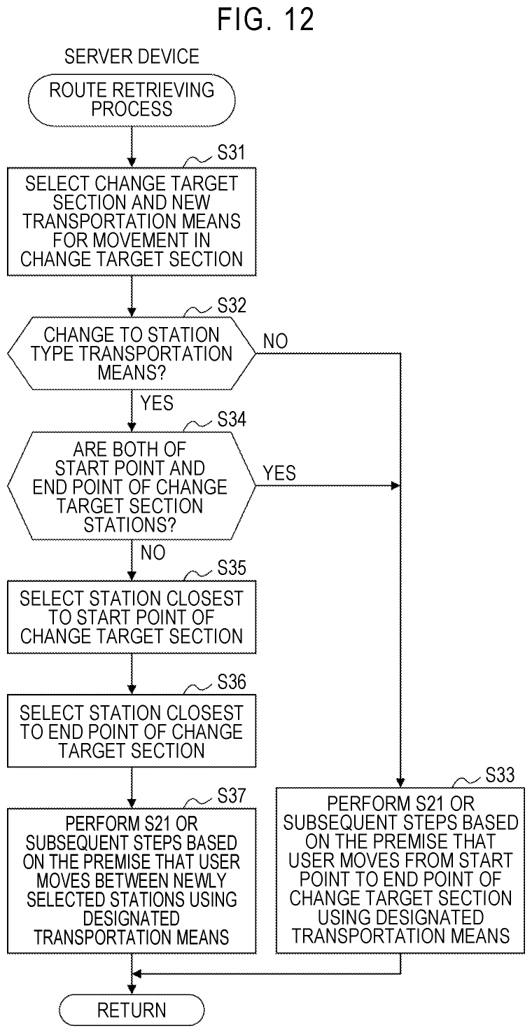

Thereafter, in S15, the CPU 21 performs a route re-retrieving process which will be described later (FIG. 12) based on the route re-retrieval request received in S14 and the map information stored in the server device 1. In the route re-retrieving process, a recommended route (a new center route) from the departure place to the destination is retrieved using the map information of the newest version stored in the server device 1 based on the route re-retrieval request received from the information terminal 5. The new center route is retrieved based on the premise that the user moves in the change target section identified in S5 using the new transportation means identified in the same way.

Then, in S16, the CPU 21 transmits information on the new center route retrieved in S15 to the information terminal 5 having transmitted the route re-retrieval request. The information on the new center route includes information for dividing the new center route into one or more sections and designating a recommended transportation means for movement in each section. When a nodal point at which the transportation means is switched is present in the new center route, the information on the new center route includes information on the nodal point.

The information terminal 5 to which the information on the new center route has been transmitted guides the user on the information on the new center route received as described above via the display 38 or the like (S8).

A sub process of the route retrieving process which is performed in S12 will be described below with reference to FIG. 9. FIG. 9 is a flowchart illustrating a program for a sub process of the route retrieving process.

First, in S21, the CPU 21 determines whether a route to a destination using a station type transportation means is to be retrieved. The station type transportation means is a transportation means of which start and end of movement are possible at only specific points (stations) such as a rented vehicle, a shared vehicle, a shared bicycle, a train, a bus, a ferry, and an aircraft. When a distance from the departure place to the destination is equal to or greater than a predetermined distance (equal to or greater than an upper-limit distance in which a user can move on foot, for example, 3 km) and several stations are present near the destination, it is determined that a route to the destination using a station type transportation means is to be retrieved. Otherwise, it is determined that a route to the destination using a transportation means other than the station type transportation means is to be retrieved. When the user's intention to move to the destination using a transportation means such as a private vehicle or a taxi other than the station type transportation means is presented in advance, it may be determined that a route to the destination using a transportation means other than the station type transportation means is to be received even if the aforementioned conditions are satisfied.

When it is determined that a route to the destination using the station type transportation means is to be retrieved (S21: YES), the process flow proceeds to S23. On the other hand, when it is determined that a route to the destination using a transportation means other than station type transportation means is to be retrieved (S21: NO), the process flow proceeds to S22.

In S22, the CPU 21 retrieves a recommended route to the destination. First, the CPU 21 selects a transportation means to the destination. In selecting a transportation means, a private vehicle is selected as the transportation means, for example, when a distance from the departure place which is a home to the destination is equal to or greater than an upper limit value (for example, 3 km). On other hand, when the distance to the destination is less than the upper limit value, walking is selected as the transportation means. Otherwise, a taxi is selected as the transportation means. In S22, a recommended route is retrieved based on the premise that the user moves from the departure place to the destination using a transportation means which is basically selected. When a private vehicle is used as the transportation means, the recommended route is retrieved based on the premise that a parking lot located near the destination is set as a nodal point and the user moves on foot from the parking lot to the destination. A known Dijkstra's algorithm is used to retrieve a recommended route and a route in which a total sum of costs is minimized is selected as the recommended route. Costs based on the transportation means are calculated in retrieval of the recommended route. For example, a cost value for a broad road such as a national road or a prefectural road is decreased when the transportation means is a private vehicle, and a cost value for a road with a sidewalk is decreased when the transportation means is walking. Particularly, when a taxi is used as the transportation means, availability of taxis is acquired from the vehicle allocation management server 7 and a route is retrieved in consideration of the availability.

Thereafter, information on the retrieved center route is transmitted to the information terminal 5 having transmitted the route retrieval request (S13).

On the other hand, in S23, the CPU 21 first retrieves a station near the departure place and selects the retrieved station as a departure station. Similarly, the CPU 21 retrieves a station near the destination and selects the retrieved station as a destination station. These stations are places in which start and end of movement of a station type transportation means are possible and examples thereof include a station, a bus stop, a ferry port, an airport, a car rental shop, and a place for rental and return of a shared vehicle or a shared bicycle. Basically, a station located at a position closest to the departure place is selected as a departure station and a station located closest to the destination is selected as a destination station, but priorities may be set depending on station types. For example, when there is a station, the station may be preferentially selected as a departure station or a destination station.

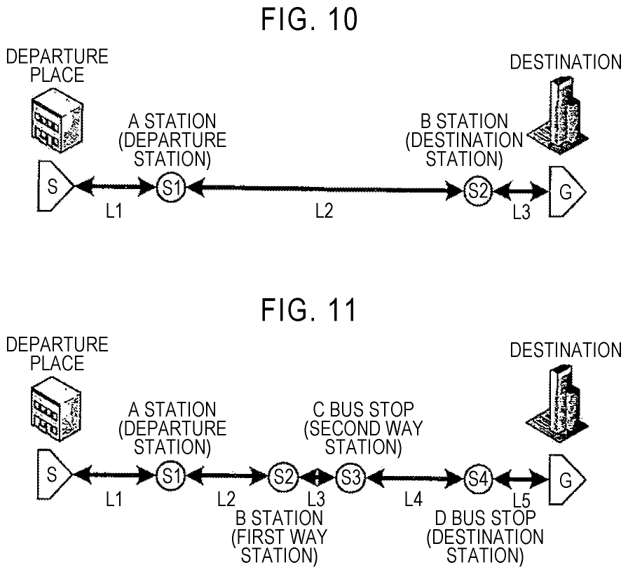

Subsequently, in S24, the CPU 21 selects a transportation means for movement from the departure station to the destination station which is selected in S23 and retrieves a recommended route for movement from the departure station to the destination station using the selected transportation means. When the departure station and the destination station are stations corresponding to the same transportation means, the transportation means is selected as the transportation means for movement from the departure station to the destination station. For example, when both the departure station and the destination station are stations as illustrated in FIG. 10, the transportation means for a route L2 from the A station which is the departure station to the B station which is the destination station is a railroad connecting the A station and the B station. When both the departure station and the destination station are bus stops, the transportation means is a bus connecting the bus stops. The recommended route from the departure station to the destination station is retrieved using a route map or a timetable of the transportation means stored in the server-side map DB 13, and a route of a shortest required time is basically retrieved. Particularly, when a rented vehicle, a shared vehicle, or a shared bicycle is used as a transportation means, availability of the transportation means is acquired from the vehicle allocation management server 7 and the route is retrieved in consideration of the availability.

On the other hand, when the departure station and the destination station are stations corresponding to different transportation means (for example, when the departure station is a station and the destination station is a bus stop), a station (a first way station) at which movement of a first transportation means having departed from the departure station ends and a station (a second way station) at which movement of a second transportation means to the destination station starts are further selected. For example, when the departure station is a station and the destination station is a bus stop as illustrated in FIG. 11, the B station in which the user alights from a train is first selected as the first way station. A C bus stop which is located near the B station and at which the user can board a bus is selected as the second way station. Thereafter, a recommended route based on movement by a train is retrieved as a route L2 from the A station which is the departure station to the B station which is the first way station. A recommended route based on movement of a bus is retrieved as a route L4 from the C bus stop which is the second way station to the D bus stop which is the destination station. A recommended route (basically movement on foot) for a route L3 from the B station which is the first way station to the C bus stop which is the second way station is also retrieved.

Then, in S25, the CPU 21 selects a transportation means for movement from the departure place to the departure station selected in S23 and retrieves a recommended route for movement from the departure place to the departure station using the selected transportation means. In selecting the transportation means, for example, a private vehicle is selected as the transportation means when a distance from a home which is the departure place to the departure station is equal to or greater than an upper limit value (for example, 3 km). On the other hand, when the distance to the departure station is less than the upper limit value, walking is selected as the transportation means. Otherwise, a taxi is selected as the transportation means. In S25, the recommended route is retrieved based on the premise that the user moves from the departure place to the departure station using the transportation means which is basically selected. When a private vehicle is selected as the transportation means, a recommended route is retrieved based on the premise that a parking lot located near the departure station is set as a nodal point and the user moves from the parking lot to the departure station by walking. A known Dijkstra's algorithm is used to retrieve the recommended route and a route in which a sum of cost values is minimized is set as the recommended route. Cost values based on the transportation means are calculated in retrieval of the recommended route. For example, a cost value for a broad road such as a national road or a prefectural road is decreased when the transportation means is a private vehicle, and a cost value for a road with a sidewalk is decreased when the transportation means is walking. Particularly, when a taxi is used as the transportation means, availability of taxis is acquired from the vehicle allocation management server 7 and a route is retrieved in consideration of the availability.

Subsequently, in S26, the CPU 21 selects a transportation means for movement from the destination station selected in S23 to the destination and retrieves a recommended route for movement from the destination station to the destination using the selected transportation means. Regarding selection of the transportation means, walking is selected as the transportation means when the distance to the destination is less than an upper limit value (for example, 3 km), and a taxi is selected as the transportation means otherwise. In S26, retrieval of a recommended route is performed based on the premise that the user moves from the destination station to the destination using the transportation means which is basically selected. A known Dijkstra's algorithm is used to retrieve the recommended route and a route in which a sum of cost values is minimized is set as the recommended route. Details thereof are the same as in S25.

Thereafter, in S27, the CPU 21 connects the recommended routes retrieved in S24 to S26 and finally determines the recommended route (the center route) from the departure place to the destination. Thereafter, the CPU 21 transmits information on the retrieved center route to the information terminal 5 having transmitted the route retrieval request (S13).

The information on the center route includes information for dividing the center route into one or more sections and designating a transportation means which is recommended for movement in a section for each section. When a nodal point at which the transportation means is switched is present in the center route, information on the nodal point is read from the server-side map DB 13 and is added to the information on the center route. Examples of the nodal point include a station, a bus stop, a parking lot, a car rental shop, a ferry port, and an airport and examples of the information on the nodal point include a position of the nodal point, a name of the nodal point (a station name, a bus stop name, or a parking lot name), and a charge or availability when the nodal point is a parking lot. In addition to the departure station, the destination station, the first way station, and the second way station which are selected in S23 and S24, a station or a bus stop for transfer between the stations serves as a nodal point. When a private vehicle is used for movement, a parking lot at which the private vehicle parks also serves as a nodal point.

A sub process of the route re-retrieving process which is performed in S15 will be described below with reference to FIG. 12. FIG. 12 is a flowchart illustrating a program for a sub process of the route re-retrieving process.

First, in S31, the CPU 21 selects a change target section which is a section which a user wants to edit out of the center route retrieved in S12 based on the route re-retrieval request received from the information terminal 5 in S14. Similarly, the CPU 21 selects a new transportation means which the user wants to use for movement in the change target section based on the route re-retrieval request received from the information terminal 5 in S14.

Subsequently, in S32, the CPU 21 determines whether the new transportation means which is desired by the user and which is selected in S31 is a station type transportation means.

When it is determined that the new transportation means desired by the user is a station type transportation means (S32: YES), the process flow proceeds to S34. On the other hand, when it is determined that the new transportation means desired by the user is a transportation means other than a station type transportation means (S32: NO), the process flow proceeds to S33.

In S33, the CPU 21 performs the route retrieving process of S21 to S27 again based on the premise that the user moves from a start point to an end point of the change target section which the user wants to edit using the new transportation means desired by the user. Exceptionally, when the new transportation means is a private vehicle, a parking lot located near the end point of the change target section is newly set as a nodal point and movement on foot from the parking lot to the end point of the change target section is added to the retrieval conditions. Then, the CPU 21 transmits information on the recommended route (the new center route) from the departure place to the destination which is newly retrieved to the information terminal 5 having transmitted the route re-retrieval request (S16).

Here, the new center route retrieved in S33 is a route in which the user moves in a section from the start point to the end point of the change target section which the user wants to edit using the new transportation means desired by the user. The new center route may be a route in which only the transportation means in the change target section is simply changed from the center route retrieved in S12 or may be a route in which a transportation means for a section other than the change target section is changed with the change of the transportation means in the change target section or a route which is greatly changed. The nodal points and the arrival time at the destination are changed and the required time and the charge required for movement are also changed.

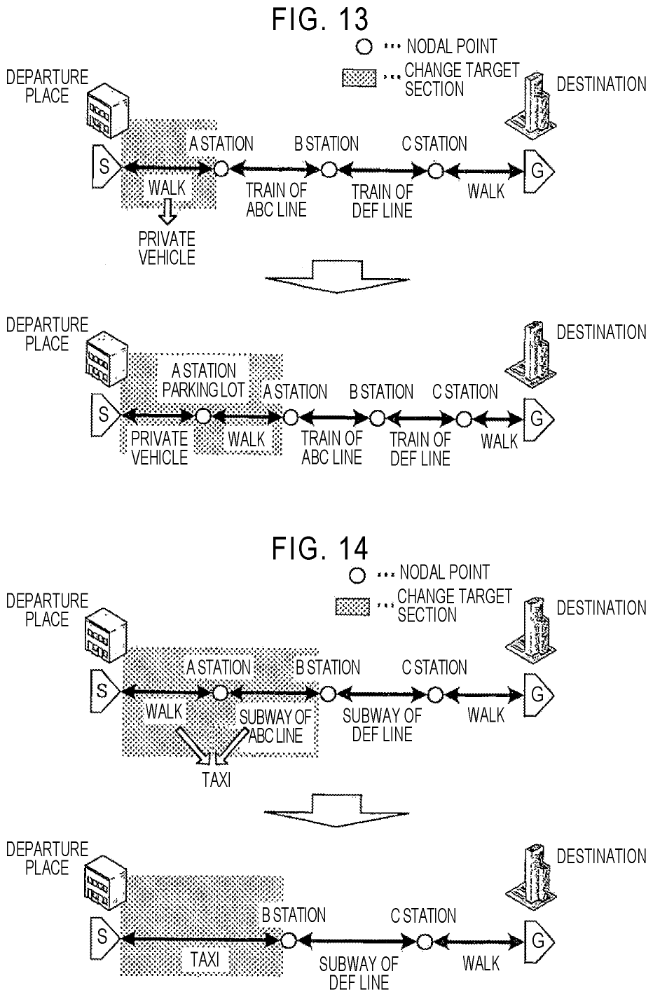

For example, FIG. 13 is a diagram illustrating change of a route when a section from a departure place to an A station which is a first nodal point is selected as the change target section and a private vehicle is newly selected as a transportation means therein. Since the private vehicle is a transportation means other than a station type transportation means, no station needs to be added as a nodal point, but it is necessary to visit a parking lot in which the private vehicle parks. Accordingly, the new center route is a route in which an A station parking lot located near the end point of the change target section, that is, the A station, is newly added as a nodal point and the user moves from the departure place to the A station parking lot using a private vehicle and walks from the A station parking lot to the A station.

FIG. 14 is a diagram illustrating change of a route when a section “from a departure place to a B station” including two sections of a section “from the departure place to the A station” and a section “from the A station to the B station” is selected as the change target section and a taxi is newly selected as a transportation means therein. Since a taxi is a transportation means other than a station type transportation means, no station needs to be added as a nodal point and a parking lot in which a private vehicle parks does not need to be visited. Accordingly, the new center route is a route in which the user moves from the departure place which is the start point of the change target section to the B station which is the end point of the change target section using a taxi. The A station is excluded from the nodal points.

On the other hand, in S34, the CPU 21 determines whether at least one of the start point and the end point of the change target section which the user wants to edit corresponds to a station corresponding to the new transportation means desired by the user. For example, when the new transportation means desired by the user is a train and both the start point and the end point of the change target section are stations, the determination result is YES. On the other hand, when at least one of the start point and the end point of the change target section is a place (for example, a home) other than a station, the determination result is NO.

When it is determined that at least one of the start point and the end point of the change target section which the user wants to edit does not correspond to a station corresponding to the new transportation means desired by the user (S34: NO), the process flow proceeds to S35. On the other hand, when it is determined that both the start point and the end point of the change target section which the user wants to edit correspond to stations corresponding to the new transportation means desired by the user (S34: YES), the process flow proceeds to S33. In S33, the route retrieving process of S21 to S27 is performed again based on the premise that the user moves from the start point to the end point of the change target section which the user wants to edit using the new transportation means desired by the user.

Here, in order to change the transportation means in the change target section to a station type transportation means, a station in which movement using the changed transportation means is started and a station in which the movement is ended basically need to be added as nodal points (S35 and S36). However, exceptionally, when both the start point and the end point of the change target section correspond to stations corresponding to the changed transportation means, no station need to be added as a nodal point.

In S35, the CPU 21 retrieves a station (for example, a subway station when the new transportation means is a train) corresponding to the new transportation means desired by the user in the vicinity of the start point of the change target section and selects a station located closest to the start point of the change target section as a start station. The start station is a station in which movement using the new transportation means desired by the user is started. When the start point of the change target section is a station corresponding to the new transportation means desired by the user, retrieval and selection of the start station of S35 are not necessary (the start point of the change target section also serves as the start station). Basically, a station located closest to the start point of the change target station is used as the start station, but the start station may be selected using a reference other than the distance (for example, a rental place for which a charge is lowest may be selected when the transportation means is a shared vehicle).

In S36, the CPU 21 retrieves a station (for example, a subway station when the new transportation means is a train) corresponding to the new transportation means desired by the user in the vicinity of the end point of the change target section and selects a station located closest to the end point of the change target section as an end station. The end station is a station in which movement using the new transportation means desired by the user is ended. When the end point of the change target section is a station corresponding to the new transportation means desired by the user, retrieval and selection of the start station of S36 are not necessary (the end point of the change target section also serves as the end station). Basically, a station located closest to the end point of the change target station is used as the end station, but the end station may be selected using a reference other than the distance.

Thereafter, in S37, the CPU 21 performs the route retrieving process of S21 to S27 again based on the premise that the user moves in a section from the start station selected in S35 to the end station selected in S36 using the new transportation means desired by the user. When the start point of the change target section is a station corresponding to the new transportation means desired by the user, a condition in which the user moves in the section from the start point of the change target section to the end station selected in S36 using the new transportation means desired by the user is used as a retrieval condition. When the end point of the change target section is a station corresponding to the new transportation means desired by the user, a condition in which the user moves in the section from the start station selected in S35 to the end point of the change target section using the new transportation means desired by the user is used as a retrieval condition. When the user moves from the start station using the new transportation means desired by the user, a condition in which the user walks from the start point of the change target section to the start station is added to the retrieval condition. When movement using the new transportation means desired by the user ends at the end station, a condition in which the user walks from the end station to the end point of the change target section is added to the retrieval condition. The CPU 21 transmits information on the recommended route from the departure place to the destination (the new center route) which is newly retrieved to the information terminal 5 having transmitted the route re-retrieval request (S16).

Here, the new center route retrieved in S37 is a route in which the user moves in at least a part of the change target section which the user wants to edit using the new transportation means desired by the user. The new center route may be a route in which only the transportation means for the change target section is simply changed, a route in which a transportation means for a section other than the change target section is changed with change of the transportation means for the change target section, or a route which is greatly changed in comparison with the center route retrieved in S12. The nodal points and the arrival time at the destination are changed and the required time or the charge for movement is changed.

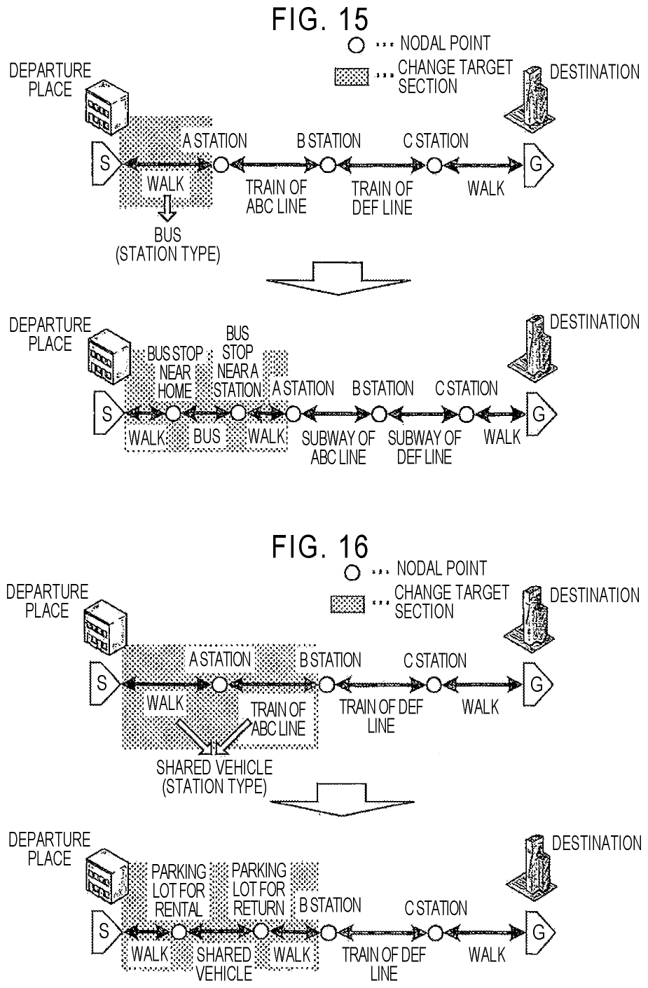

For example, FIG. 15 is a diagram illustrating change of a route when a section from a departure place to an A station which is a first nodal point is selected as the change target section and a bus which is a station type transportation means is newly selected as a transportation means therein. Since the bus is a station type transportation means, a station at which the user's boarding the bus is started and a station in which the user's boarding the bus is ended need to be added as nodal points. Accordingly, in the new center route, the start point of the change target section, that is, a bus stop near the home in the vicinity of the departure place, is newly added as a nodal point and the end point of the change target section, that is, a bus stop near the A station in the vicinity of the A station, is newly added as a nodal point. The new center route is a route in which the user walks from the departure place to the bus stop near the home, moves from the bus stop near the home to the bus stop near the A station using a bus, and walks from the bus stop near the A station to the A station.

FIG. 16 is a diagram illustrating change of a route when a section “from a departure place to a B station” including two neighboring sections of a section “from the departure place to the A station” and a section “from the A station to the B station” is selected as the change target section and a shared vehicle which is a station type transportation means is newly selected as a transportation means therein. Since the shared vehicle is a station type transportation means, a station at which the user's boarding the shared vehicle is started and a station in which the user's boarding the shared vehicle is ended need to be added as nodal points. Accordingly, in the new center route, the start point of the change target section, that is, a parking lot for rental of a shared vehicle in the vicinity of the departure place, is newly added as a nodal point and the end point of the change target section, that is, a parking lot for return of a shared vehicle near the B station, is newly added as a nodal point. The new center route is a route in which the user walks from the departure place to the parking lot for rental of a shared vehicle, moves from the parking lot for rental of a shared vehicle to the parking lot for return of a shared vehicle using a shared vehicle, and walks from the parking lot for return of a shared vehicle to the B station. On the other hand, the A station is excluded from the nodal points.

As the processing results of S31 to S37, a user can ascertain a route to a destination which is temporarily retrieved, then designate a section which the user wants to edit, and designate a transportation means for the section. Since the server device 1 re-retrieves a route according to the user's designation, a new route which is re-retrieved can be a route desired by the user.

In the route re-retrieving process, when movement in the change target section using a new transportation means desired by the user is substantially impossible (for example, there is no transportation means in a corresponding time period) or is not realistic (an arrival time is greatly delayed), a route in which the user moves using a transportation means other than the new transportation means desired by the user may be retrieved.

As described above in detail, with the server device 1 according to this embodiment and the computer program which is executed by the server device 1, guidance of a user for a route to a destination is retrieved and then route information for identifying the retrieved route is performed (S13), one section included in the retrieved route is selected as a change target section based on the user's later operation and a new transportation means for movement in the change target section is selected (S31), and a route to the destination is re-retrieved based on the premise that the user moves in the change target section using the selected new transportation means (S33, S37). Accordingly, since the temporarily retrieved route can be edited to a route in which the user moves in the arbitrary section designated by the user using the transportation means designated by the user, it is possible to easily retrieve a route desired by the user.

An applicable embodiment of the present disclosure is not limited to the aforementioned embodiment and can be subjected to various improvements and modifications without departing from the gist of the present disclosure. For example, in this embodiment, when a route to a destination is retrieved, a detailed route (what path the user passes through) between nodal points is retrieved in addition to a transportation means used for movement and the nodal points at which the transportation means is switched, but the detailed route may not be retrieved. That is, only information on the transportation means used for movement and the nodal points (for example, a station name and a departure time of a train) may be provided to a user.

In this embodiment, when a user selects a change target section which the user wants to edit, a start point and an end point of the change target section are selected out of nodal points included in a center route, but the change target section may be selected using another method. For example, a user may select a section which the user wants to edit on the route editing screen 55 by a dragging operation. The change target section may not necessarily employ nodal points as the start point and the end point.

In this embodiment, the route retrieving process (S12) or the route re-retrieving process (S15) is performed by the server device 1, but parts or all of the route retrieving process and the route re-retrieving process may be performed by the information terminal 5. In this case, map information is stored in the memory of the information terminal 5 or the information terminal 5 acquires map information from a server and the information terminal 5 performs the route retrieving process or the route re-retrieving process using the map information. That is, the route retrieval device according to the present disclosure may be the server device 1 or the information terminal 5.

In this embodiment, a smartphone is employed as the information terminal 5, but another type of information terminal may be used as long as it has a function of guiding a user on a retrieved route. For example, the present disclosure may be applied to a mobile phone, a tablet type terminal, a personal computer, or a navigation device which is an onboard device.

An embodiment of the route retrieval device according to the present disclosure has been described above, but the route retrieval device may have the following configurations. In this case, the following advantages are obtained.

For example, a first configuration is as follows: A route retrieval device including: a route retrieving unit (21) configured to retrieve a route to a destination which is divided into one or more sections and in which a transportation means recommended for movement in a section is designated out of a plurality of types of transportation means for each section; a route guidance unit (21) configured to guide a user with route information for identifying a retrieved route which is a route retrieved by the route retrieving unit; a section selecting unit (21) configured to select one section included in the retrieved route as a change target section based on a user's operation; a transportation means selecting unit (21) configured to select a new transportation means for movement in the change target section based on the user's operation; and a route re-retrieving unit (21) configured to re-retrieve a route to the destination based on the premise that the user moves in the change target section using the new transportation means selected by the transportation means selecting unit. With the route retrieval device having this configuration, when a transportation means used for movement is selected out of a plurality of types of transportation means and a route is retrieved, a user can edit a temporarily retrieved route to a route in which the user moves in an arbitrary section designated by the user using a transportation means designated by the user and thus it is possible to easily retrieve a route desired by the user.

A second configuration is as follows: The route retrieval device, wherein the section selecting unit (21) is configured to select a plurality of neighboring sections as the change target section, and the transportation means selecting unit (21) is configured to select a new transportation means for movement in the plurality of neighboring sections selected as the change target section. With the route retrieval device having this configuration, when a user wants to change a nodal point at which a transportation means is switched or when a user wants to reduce the number of nodal points (for example, when the user wants to change a boarding station or to change an alighting station) in a temporarily retrieved route, it is possible to easily retrieve a route desired by the user.

A third configuration is as follows: The route retrieval device, wherein the transportation means selecting unit (21) is configured to select one transportation means for the plurality of neighboring sections selected as the change target section, and the route re-retrieving unit (21) is configured to re-retrieve a route to the destination based on the premise that the user moves from a start point of the plurality of neighboring sections selected as the change target section to an end point thereof using the transportation means selected by the transportation means selecting unit. With the route retrieval device having this configuration, when a user wants to reduce the number of nodal points (for example, the user wants to reduce the number of transfers) in a temporarily retrieved route, it is possible to easily retrieve a route desired by the user.

A fourth configuration is as follows: The route retrieval device, wherein the retrieved route is divided into a plurality of sections at nodal points at which the transportation means is switched. With the route retrieval device having this configuration, since a user is guided along a route which is divided at the nodal point at which a transportation means is switched, it is possible to simply guide the user even along a route in which the user moves by transferring between a plurality of transportation means.

A fifth configuration is as follows: The route retrieval device, wherein the route guidance unit (21) is configured to guide the user to the nodal points included in the retrieved route, a start point of the retrieved route, and an end point of the retrieved route as the route information, and the section selecting unit (21) is configured to select a section from a first point designated by the user to a second point designated by the user out of the nodal points, the start point of the retrieved route, and the end point of the retrieved route along which the user is guided by the route guidance unit (21) as the change target section. With the route retrieval device having this configuration, it is possible to guide a user along a route which is divided at a nodal point at which a transportation means is switched and to allow a user to easily designate a section in which editing of the route is desired using the nodal point to which guidance is performed.

A sixth configuration is as follows: The route retrieval device, wherein each nodal point is one of a station, a bus stop, a parking lot, a car rental shop, a ferry port, and an airport. With the route retrieval device having this configuration, since a user is guided along a route which is divided at a nodal point at which a transportation means is switched, it is possible to simply guide the user even along a route in which the user moves by transferring between a plurality of transportation means such as a train, a bus, a private vehicle, a rented vehicle, a ferry, and an aircraft.

What is claimed is:

1. A route retrieval device comprising:
a route retrieving unit configured to retrieve a route to a destination which is divided into one or more sections and in which a transportation means recommended for movement in a section is designated out of a plurality of types of transportation means for each section;
a route guidance unit configured to guide a user with route information for identifying a retrieved route which is a route retrieved by the route retrieving unit;
a section selecting unit configured to select one section included in the retrieved route as a change target section based on a user's operation;
a transportation means selecting unit configured to select a new transportation means for movement in the change target section based on the user's operation; and
a route re-retrieving unit configured to re-retrieve a route to the destination based on the premise that the user moves in the change target section using the new transportation means selected by the transportation means selecting unit.

2. The route retrieval device according to claim 1, wherein the section selecting unit is configured to select a plurality of neighboring sections together as the change target section, and
wherein the transportation means selecting unit is configured to select a new transportation means for movement in the plurality of neighboring sections selected as the change target section.

3. The route retrieval device according to claim 2, wherein the transportation means selecting unit is configured to select one transportation means for the plurality of neighboring sections selected as the change target section, and
wherein the route re-retrieving unit is configured to re-retrieve a route to the destination based on the premise that the user moves from a start point of the plurality of neighboring sections selected as the change target section to an end point thereof using the transportation means selected by the transportation means selecting unit.

4. The route retrieval device according to claim 1, wherein the retrieved route is divided into a plurality of sections at nodal points at which the transportation means is switched.

5. The route retrieval device according to claim 4, wherein the route guidance unit is configured to guide the user to the nodal points included in the retrieved route, a start point of the retrieved route, and an end point of the retrieved route as the route information, and
wherein the section selecting unit is configured to select a section from a first point designated by the user to a second point designated by the user out of the nodal points, the start point of the retrieved route, and the end point of the retrieved route along which the user is guided by the route guidance unit as the change target section.

6. The route retrieval device according to claim 4, wherein each nodal point is one of a station, a bus stop, a parking lot, a car rental shop, a ferry port, and an airport.

7. A computer program causing a computer to serve as:
a route retrieving unit configured to retrieve a route to a destination which is divided into one or more sections and in which a transportation means recommended for movement in a section is designated out of a plurality of types of transportation means for each section;
a route guidance unit configured to guide a user with route information for identifying a retrieved route which is a route retrieved by the route retrieving unit;
a section selecting unit configured to select one section included in the retrieved route as a change target section based on a user's operation;
a transportation means selecting unit configured to select a new transportation means for movement in the change target section based on the user's operation; and
a route re-retrieving unit configured to re-retrieve a route to the destination based on the premise that the user moves in the change target section using the new transportation means selected by the transportation means selecting unit.
